(19) United States
(12) Patent Application Publication
(10) Pub. No.: US 2007/0216193 A1
(43) Pub. Date: Sep. 20, 2007

(54) Car cover and car cover deployment system

(76) Inventor: Stephen Edward Webber, Beachwood, OH (US)

Correspondence Address: Stephen E. Webber, 26300 Seville Drive #209, Beachwood, OH, 44122, US

(21) Appl. No.: 11/384,529

(22) Filed: Mar. 20, 2006

(51) Int. Cl. B60J 11/04

(52) U.S. Cl. 296/136.01

(57) ABSTRACT

A protective flexible car cover which is designed to be attached and detached to a foldable deployment rod which facilitates deploying and removing the car cover without any motorized aids and which also provides for convenient storage of the car cover when it is not in use. The attachment of the car cover to the deployment rod is conveniently effected by a material like Velcro®. The car cover has magnets or weights around its periphery to help hold the cover in place while being deployed and after deployment. Additional panels on the underside of the car cover and at the rear of the car cover are provided which can be held in place by the side doors of the vehicle or by the trunk lid or rear door of the vehicle.

### REFERENCES CITED

### US Patent Documents

| | | | |
|---|---|---|---|
| 4324427 | April, 1982 | Huang et al. | 293/106 |
| 4657298 | April, 1987 | O | 296/136.03 |
| 4718711 | February, 1988 | Rabbit | 296/136.03 |
| 4834446 | May, 1989 | Tung-Chow | 296/136.03 |
| 4842324 | June, 1989 | Carden | 296/136.11 |
| 4958881 | September, 1990 | Piros | 296/98 |
| 5176421 | January, 1993 | Fasiska | 296/136.03 |
| 5188417 | February, 1993 | Curchod | 296/136.04 |
| 5242206 | September, 1993 | Heck | 296/136.02 |
| 5401074 | March, 1995 | Timerman. | 296/136.02 |
| 5409286 | April, 1995 | Huang | 296/136.04 |
| 5456515 | October, 1995 | Dang | 296/95.1 |
| 5597196 | January, 1997 | Gibbs | 296/98 |
| 5597197 | January, 1997 | Mowar et al. | 296/136.04 |
| 5664825 | September, 1997 | Henke et al. | 296/136.02 |
| 5800006 | September, 1998 | Pettigrew. | 296/136.02 |
| 5855406 | January, 1999 | Vargo | 296/136.03 |
| 6220648 | April, 2001 | Daniel | 296/136.02 |

CoolCar™, Crown Publishing Company, 26949 Whitehorse, Santa Clarita, CA 91387
Roll up™ car cover, sold online at http://thecarcover.com/ or Infomercial.TV. Inc., P.O. Box 2667, Venice, CA 90294
DuPont Tyvek® or Tyvek® Plus at the website http://www.tyvek.com/na/covers/english/carcover.html
Kimberly-Clark NOAH® or BLOCK IT® Evolution and related products, described at the website http://www.block-it.com/home.htm
Car Cover Direct, at the website http://www.carcoversdirect.com/car covers.php
Car Cover World, at the website http://www.carcoverworld.com/

### FEDERALLY SPONSORED RESEARCH

This invention was not the result of any Federally sponsored research project

### BACKGROUND OF THE INVENTION

1. Field of the Invention

There are many different car covers available in the open market and even more have been the focus of prior patents. Most such covers teach the use of a flexible cloth material. The reasons to use a car cover can include at least the following: 1) diminish heating the interior of the vehicle when parked in the sun with the concomitant discomfort to passengers, 2) protection of the exterior of the vehicle against sun exposure, bird droppings, sap from trees, chemicals such as oil contained in the runoff encountered in some garage facilities, blowing sand and/or salt encountered near the seashore etc. 3) protection of the interior of the vehicle against sun exposure and heating, 4) protection of the exterior of a car against impact, such as encountered in hail storms or accidental minor collisions during transportation. Car covers can be various sizes, depending on the envisioned use. For example, to minimize solar heating and sun/heat damage to the vehicle interior it is only necessary to cover the window spaces to obtain a beneficial effect. The benefits of an exterior cover are documented by the Dupont company in their information about their materials Tyvek® or Tyvek® Plus on their website http://www.tyvek.com/na/covers/english/carcover2.html. If all exterior surfaces are to be protected then the car cover must fit around the entire vehicle. In general covering a car with a flexible material resistant to sun and other damaging elements of nature is not convenient, nor is the storage of the cover when not in use. The cover must be held onto the vehicle firmly to resist the effects of wind or to minimize the potential for theft of the cover, which often leads to a multiple tie-down design that is also inconvenient and time-consuming. These factors tend to discourage users from buying car covers or even using a car cover unless the vehicle is expected to be out of use for a significant period of time. Thus there is a need for a simple car cover assembly that makes the deployment and removal of the cover quick and convenient and one that can be stored quickly and compactly when not in use, such that the owner would be willing to use the assembly for relatively short periods of parking. It is preferable not to make any permanent installations on the vehicle exterior or truck storage area to accomplish these aims.

2. Description of Prior Art

There are many designs for car covers per se that do not necessarily have any provision for improved ease of deployment. For example there are a number of examples of a car cover designed to protect a vehicle against impact, using an energy-absorbing material (Daniel, April, 2001, U.S. Pat. No. 6,220,648; Pettigrew, September, 1998, U.S. Pat. No. 5,800,006; Henke et al., September, 1997, U.S. Pat. No. 5,664,825; Timerman, March, 1995, U.S. Pat. No. 5,401,074; Heck, September, 1993, U.S. Pat. No. 5,242,206), which would obviously be relatively difficult to deploy and no provision is made for deployment of the car cover in these patents.

There are a number of designs in the patent literature in which a roller device is mounted in the trunk area of a vehicle for the purpose of holding a car cover (Vargo, January, 1999, U.S. Pat. No. 5,855,406; Gibbs, January, 1997, U.S. Pat. No. 5,597,196; Dang, October, 1995, U.S. Pat. No. 5,456,515; Huang, April, 1995, U.S. Pat. No. 5,409,286; Curchod, February, 1993, U.S. Pat. No. 5,188,417; Fasiska, January, 1993, U.S. Pat. No. 5,176,421; Piros, September, 1990, U.S. Pat. No. 4,958,881; Carden, June, 1989, U.S. Pat. No. 4,842,324; Tung-Chow, May, 1989, U.S. Pat. No. 4,834,446; Rabbit, February, 1988, U.S. Pat. No. 4,718,711; O, April, 1987, U.S. Pat. No. 4,657,298; Mowar et al., January, 1997, U.S. Pat. No. 5,597,197. In the U.S. Pat. No. 5,855,406 to Vargo, January 1999 a spring-biased rollup system for a car cover that is stored in the car trunk for a car cover is taught. This system is considerably more complex than the simple deployment device in the present invention, which does not require any spring or motor-aided actions. A similar spring-aided roller system is taught in the U.S. Pat. No. 5,597,196 to Gibbs, January 1997 and U.S. Pat. No. 5,456,515 to Dang, October, 1995. This device is fixed within the vehicle trunk area, which will interfere with normal storage in the trunk as well as require being fixed to the interior walls of the trunk. The present invention does not require any mounts to be fixed to any portion of the vehicle. In U.S. Pat. No. 4,324,427 to Huang et al., April, 1982 a car bumper is modified to hold a spring-activated roller on which a car cover is mounted. In additional to the mechanical complexity of this device, a permanent fixture must be added to the automobile. In U.S. Pat. No. 5,176,421 to Fasiska, January, 1993 an electrically driven roller system is taught, in addition to the use of a hand crank or a spring-actuated system. In this case a containment tube for the cover is mounted in the vehicle trunk. A motor, spring or manually operated roller system that mounts to the underside of the vehicle trunk lid is taught by U.S. Pat. No. 4,958,881 to Piros, September, 1990. A very similar device is taught in U.S. Pat. No. 4,657,298 to O, April, 1987. In U.S. Pat. No. 4,834,446 to Tung-Chow, May., 1989 a mechanically cranked or electric-motor actuated device that remains in the vehicle trunk winds a belt to which the car cover is attached is taught. While requiring less volume that a trunk-mounted roller, the system is mechanically complex and does not aid the user in spreading the car cover evenly over the surface of the vehicle, which is accomplished in the present invention. In U.S. Pat. No. 4,718,711 to Rabbit, February, 1988 a double roller-bar system is taught, one end of which is attached to the interior of the trunk and which requires both roller bars to reside on the vehicle exterior when the car cover is deployed. While the use of a roller bar is expected to aid in the deployment of the car cover, in order to be useful the bar must be at least the width of the vehicle, which makes it less convenient for storage. The present invention avoids this inconvenience by allowing the deployment device to be removed when the car cover is in place. In U.S. Pat. No. 5,597,197 to Mowar et al., January, 1997 there is no mechanical deployment aid but a cross-member attached to the front of the car cover is taught, which is supposed to aid in the deployment of the cover. Unlike the present invention, this cross-member is not designed to deploy the cover by a simple rolling action but instead requires the user to support the weight of the cover plus cross-member. Depending on the weight of the car cover material this is likely to be awkward to carry out.

There are a number of designs for a car cover alone, with no provision for improving the ease of deployment. For example U.S. Pat. No. 5,409,286 to Huang, April, 1995 teaches the use of a form-fitting cover with an elastic band on the periphery of the cover to hold the cover more tightly to the passenger compartment of the vehicle. This obviously is a more difficult cover to deploy or remove than the present invention. In U.S. Pat. No. 5,188,417 to Curchod, February, 1993 a similar system is described except that explicit provision is made for a storage pouch that is mounted in the trunk. The present invention does not require that the storage of the car cover be located in any specific part of the vehicle. In U.S. Pat. No. 4,842,324 to Carden, June, 1989 a four-sided cab cover is described in which a better fit to the car contour is proposed by employing V-shaped cuts in the covering material. Tubular attachments to the cover are described which are supposed to help hold the cover in place and in particular the rear-most tube is supposed to reside in the trunk of the vehicle in order to fix the cover in place, requiring the user to open and close the vehicle trunk each time the cover is used. The present invention allows the user to attach the car cover by enclosing it in the passenger compartment with specifically designed panels as well as with a panel located such that it can be enclosed in the truck, at the user's option.

There are a number of commercial car cover products. For example see the following companies and their websites: 1) Car Covers Direct, at the website http://www.carcoversdirect.com/car covers.php 2) Car Cover World, at the website http://www.carcoverworld.com/. All of the covers offered for sale are large sheets of a size to fit a particular vehicle or class of vehicles, attached to the vehicle by an elastic material that runs around the periphery of the cover and fits under the vehicle carriage. None of these products have any provision to aid in the deployment of the car cover. The fact that deployment and removal of a car cover is inconvenient is reflected in the two products CoolCar™ car cover and Roll up™ car cover. The CoolCar™ car cover teaches the use of padded weights around the edge of the cover, to help facilitate throwing the car over the top of the vehicle. This is a completely different approach to rolling and unrolling the car cover, as disclosed in the present invention. The CoolCar™ can be held firmly in place by closing the doors on the cover, thereby trapping a portion of the reflective material inside the car, where heat can be partially trapped, as well as causing additional wear and tear on the cover itself. In the present invention there are specific panels on the underside of the car cover for this purpose. For the Roll up™ car cover an electric windup device is used to roll the car cover inside a drum, unlike the present invention which does not use any motorized devices and rolls the car cover onto a foldable rod (referred to as the “deployment wand”). While the Roll up™ approach provides convenient storage for the car cover and should be effective in helping remove the car cover, it is not obvious that it facilitates deployment of the car cover.

### SUMMARY OF THE INVENTION

1. Summary

The invention is composed of two parts. The first is a car cover with a number of small weights or magnets mounted around the periphery of the cover to hold it in place while deployed, either by the force exerted by the weights or by magnetic attraction to the vehicle body if said body is composed of a metal with a magnetic susceptibility, as is typical of steel alloys. Additionally the car cover has several panels on its underside which can be inserted into the vehicle doors before they are closed or into the vehicle trunk before it is closed, thereby providing additional mechanical stability against wind or theft. Additional side attachments that may be fixed to external rear-view mirrors may also be used for additional mechanical stability. When the car cover is fully deployed it will cover the front, back and all side windows as well as the vehicle top and all or part of the front (hood) and back (trunk) sections of the vehicle body.

2. Objective of the Invention

It is the objective of the invention to provide a car cover assembly that can be deployed or removed quickly by one person and stored conveniently in any storage area available in the vehicle. Another objective is to provide a deployment device to hold any flexible material that can be folded to minimize the storage space it requires, with or without the flexible material in place. Another object is to provide a car cover design that allows all windows to be covered and which is held in place by a combination of weights or magnets around the periphery of the cover and provision for being held in place by the doors and the truck of the vehicle, to accomplish stability against the wind and to discourage theft. The objective of the car cover itself is to minimize the buildup of interior heating when a car is parked in the sun, to protect the car against the elements such as interior or exterior damage from natural or artificial light, sap or other secretions from trees or other plans, bird or other animal droppings that might occur when a vehicle is parked under trees or other areas where birds or animals may inhabit, natural or unnatural damaging liquids such as sea spray, paint spray, chemicals that are present in the surrounding environment etc.

### BRIEF DESCRIPTION OF DRAWINGS

FIG. 1 is an underside view of the car cover so that the addition attachment panels are shown more clearly and a view of the deployment wand.

FIG. 2 is a more detailed drawing of the preferred embodiment of the deployment wand showing the internal support rod in the forward open deployment position.

FIG. 3 is a more detailed drawing of the deployment wand showing the internal support rod in the withdrawn position for folding the deployment wand (closed position).

FIG. 4 is a topside view of the car cover illustrating an alternative embodiment of the invention.

FIG. 5 is a view of an alternative embodiment of the deployment wand, referred to as “alternative wand number 1”. FIG. 6 is a view of an alternative embodiment of the deployment wand, referred to as “alternative wand number 2”.

### REFERENCE NUMBERS IN THE DRAWINGS

| | |
|---|---|
| 10 | Magnets or small weights fixed to the periphery of the car cover (as shown, 18) |
| 12, | Panels fixed to the car cover which may be secured in the driver and passenger side doors |
| 12′ | and the rear trunk compartment |
| 14 | A plastic or fabric tube added to the back panel to facilitate trapping the rear security |
| | panel in the vehicle trunk |
| 16 | Velcro ® strips or the like (which will be used to attach the car cover to the deployment |
| | wand) |
| 18 | The deployment wand (a hollow tube) |
| 20 | Velcro strips or the like, wound onto the wand and which will be used to attach the wand |
| | to the car cover using the Velcro strips 14 |
| 22 | A flexible joining piece between the two parts of the deployment wand, constructed from |
| | either flexible tubing or a metallic spring or the like, to allow the deployment wand to be |
| | folded for storage with or without the car cover rolled onto it |
| 24 | A rod constructed from plastic, metal or wood that when forward position prevents the |
| | deployment wand from bending at the flexible join 22 and facilitates rolling the car cover |
| | onto or off of the wand. |
| 26, | A mechanical stop placed into the body of the deployment wand to prevent the rod 24 |
| 26′ | from falling out of the deployment wand |
| 28 | A handle on the tubular deployment wand to facilitate rolling the car cover onto the wand. |
| | This handle may be removable. |
| 30 | Elastic cord or other attachment to hold the folded wand in the closed position for storage |
| 32 | Fabric or plastic join between the two sheets composing the car cover |
| 34 | Foldable wand including a transverse handle for ease of deployment. This handle may be |
| | removable. |
| 36, | Lower section of the foldable wand, with open yoke at the end away from the handle, to |
| 36′ | accommodate the upper section |
| 38 | Upper section of the foldable wand |
| 40, | Join between upper and lower sections, which allows rotation of the two pieces between |
| 40′ | the open and closed position |
| 42 | A pin that joins the upper and lower sections of the wand, such that the two sections can |
| | be rotated with respect to each other |
| 44, | Join between the upper and lower part of the foldable wand |
| 44′ | |
| 46, | Upper section of the foldable wand |
| 46′ | |
| 48, | Lower section of the foldable wand |
| 48′ | |
| 50 | A pin that joins the upper and lower sections of the wand to the join 44, such that the two |
| | sections can be rotated into the folded configuration |

### DETAILED DESCRIPTION OF THE INVENTION

1. Preferred Embodiment

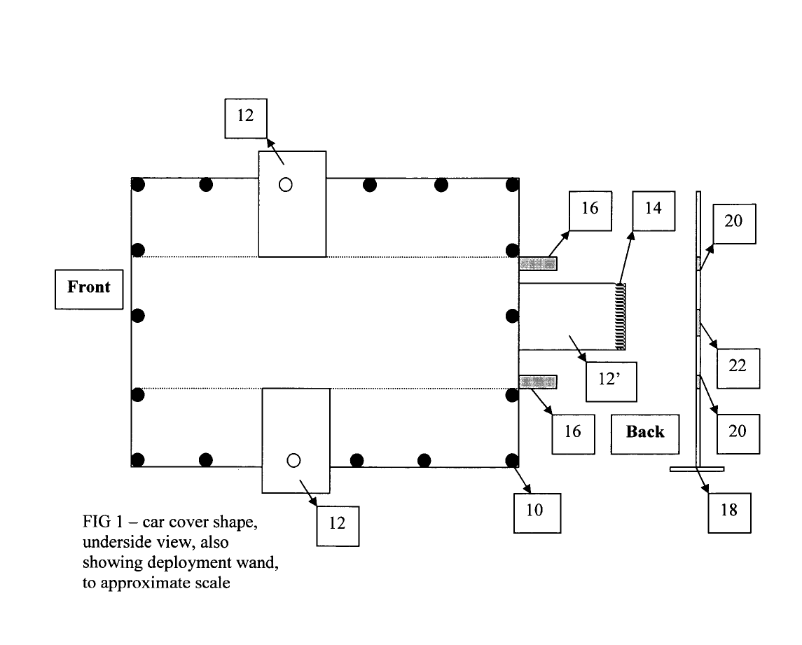

FIG. 1 shows the car cover which may be constructed from a single sheet of appropriate material (such as Tyvek®, manufactured by DuPont or NOAH® and BLOCK IT® Evolution, both manufactured by Kimberly-Clark). Small magnets or weights 10 are attached to the periphery of the car cover to facilitate deployment and help hold the car cover in place after deployment. Two panels 12 are fixed to the underside of the car cover which may be held in place by the closed driver-side and passenger-side doors for additional stability. An additional panel 12' at the back of the car cover can be closed inside the trunk of the vehicle for the same purpose. A plastic tube or the like 14 can be fixed to panel 12' to provide a more convenient hand-hold and to facilitate placing it in the trunk compartment. The use of these panels is discretionary as they provide addition stability and security beyond the use of just the magnets or weights 10. Two Velcro® strips 16 are fixed to the back of the car cover spaced such that they match up with the Velcro® surfaces 20 on the deployment wand 18. This allows the car cover to be attached and detached from the deployment wand for deployment or removal of the car cover. Note that the active surfaces of the Velcro® strips 16 are faced away from the viewer of FIG. 1, which is an underside view. The T-handle on the deployment wand 18 is used to facilitate rolling the car cover onto the car or rolling up the car cover when it is removed from the car. The deployment wand has a flexible joining member 22 that holds the two halves together and allows the deployment wand to be folded with or without the car cover rolled onto it for storage.

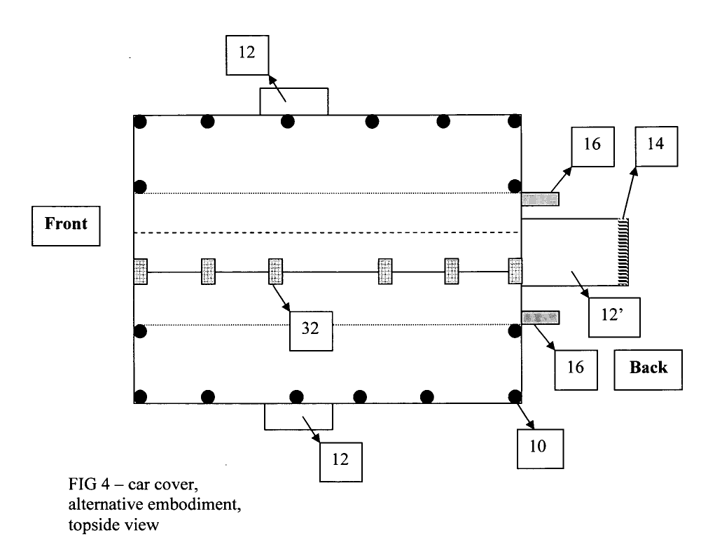

In the preferred embodiment of this invention the car cover the deployment wand 18 with the car cover rolled onto is placed at the front of the vehicle. For definiteness we will assume that the T-handle of 18 is on the driver's side of the car. Assuming that the panels 12 were in the down position when the car cover was rolled onto the deployment wand in the orientation then the panels 12 will also be on the underside of the deployed car cover. The front magnets or weights hold the car cover in place as it is unrolled from the deployment wand in the direction of the rear of the vehicle. The car cover will have been folded approximately along the dashed line shown in FIG. 1 such that the magnets or weights will initially rest on the vehicle roof, also serving to hold the car cover in place during deployment. When the car cover is fully deployed the deployment wand is resting on the vehicle trunk area or hanging loosely in the case of a vehicle without a trunk (e.g. a van or hatchback vehicle). At this point the front and back windows are completely covered. The deployment wand is removed from the Velcro® strips of the car cover and can be folded for storage (see the discussion of folding the deployment wand in FIG. 3). Then at the user's discretion the panels 12 can be inserted into the vehicle by closing the driver side and passenger side doors on them and panel 12' can be inserted into the trunk area in a similar way. The remaining portion of the car cover can be unfolded from the car roof in order to cover the side windows of the vehicle. The width of the cover is sufficient that the magnets or weights 10 hang below the windows and will help hold the cover in position to cover all side windows. Thus all windows are covered and depending on the exact size of the cover, much of the vehicle hood and trunk exterior surface is covered.

Removal of the car cover follows a similar procedure. The deployment wand 18 is configured to the open position (see FIG. 3 details for how this is accomplished) and attached by the Velcro® strips to the car cover with the T-handle on the driver side of the vehicle. The panels 12 and 12′ are removed from the front doors and trunk respectively. The portion of the car cover hanging over the side windows is folded on top of the vehicle, with the magnets or weights holding the cover loosely in place. Starting from the rear of the vehicle, using the T-handle to facilitate rotation of the deployment wand, the car cover is rolled onto the deployment wand while the user walks toward the front of the vehicle. After the car cover is completely rolled onto the deployment wand 18, the deployment wand is folded (see FIG. 3) and the cover plus deployment wand can be stored in the vehicle or vehicle trunk.

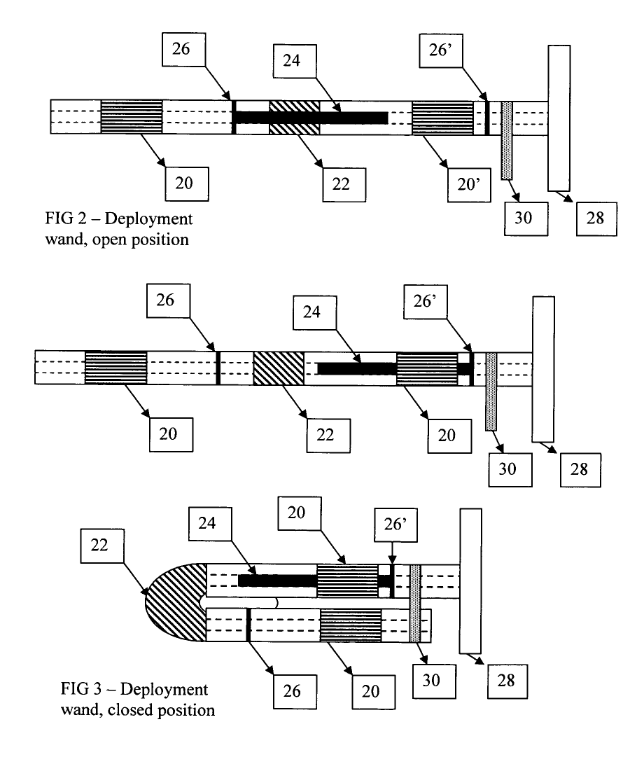

FIG. 2 shows the tubular deployment wand 18 in the open deployment position. Two pieces of Velcro® or the like 20 are attached to the exterior of the deployment wand with the active surfaces facing outward and spaced such that they match up with the Velcro® strips 16 on the car cover. The wand can be constructed of any suitable light weight tubular material (plastic or metal) and consists of two parts with a flexible join 22 which can be plastic tubing or a spring. The flexible join 22 must be fixed securely to the exterior of the wand and have sufficient interior diameter to allow the support rod 24 to slide through it when the wand is in the open position such that the support rod 24 in the position shown in FIG. 2, resting against the forward stop 26, prevents the deployment wand from bending at the flexible join 22. This stiffens the deployment wand and greatly facilitates rolling out (deployment) or rolling up (removal) of the car cover. The fact that the flexible join is fixed securely to the deployment wand exterior assures that the two parts of the deployment wand rotate together during deployment or removal of the car cover. The T-handle 28 allows the user to rotate the deployment wand more easily during deployment or removal of the car cover. The T-handle 28 may be fixed permanently to one end of the deployment wand or be removable for additional ease of storage. An elastic cord or the like 30 is used to hold the deployment wand in a closed position for storage.

FIG. 3 shows the deployment wand 18 configured for folding and storage, with or without the car cover rolled onto it. In doing from the open configuration in FIG. 2 to the closed and folded position of FIG. 3 the user would hold the T-handle 28 down and allow the support rod 24 to slide to the lower position, resting against the stop 26′. Then the deployment wand can be folded around the flexible join 22 and finally held in place using the elastic cord 30. To go from the closed and folded configuration to the open one the user releases the elastic cord 30, straightens the deployment wand and holds the T-handle 28 up, allowing the support rod 24 to pass through the flexible join 22 and come to rest on the stop 26. This stiffens the deployment wand 18 and facilitates deploying or removing the car cover.

2. Description of Other Embodiments

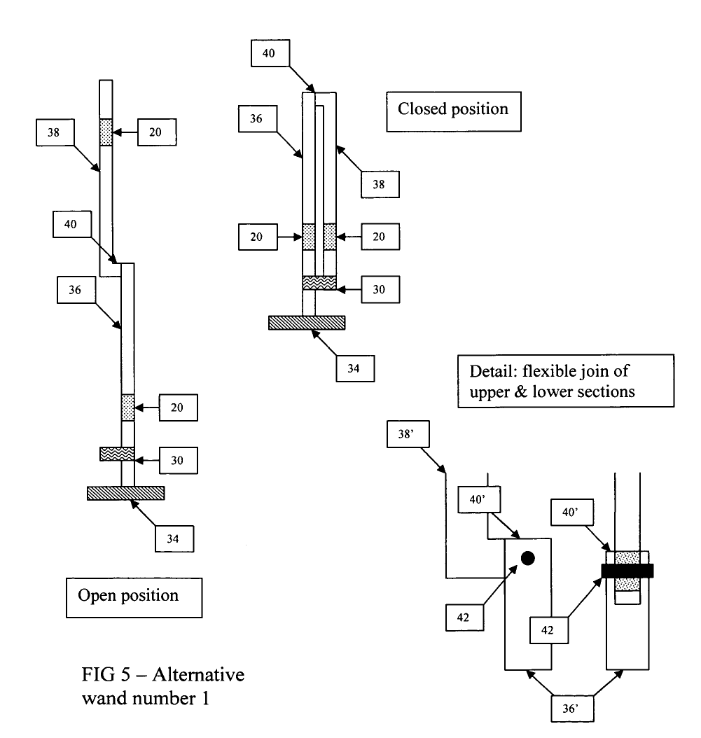

FIG. 4 shows an alternative embodiment of the present invention, to be used in the case that the car cover material is insufficiently flexible to accommodate the folding required for the closed and folded (storage) position. In this case the car cover is composed of two overlapping sheets of material, joined by strips of suitable flexible material at the front, back and several intermediate positions along their length. The fold will occur at the point of the sheet overlap, such that there will be sufficient flexibility for the folding to be accomplished conveniently.

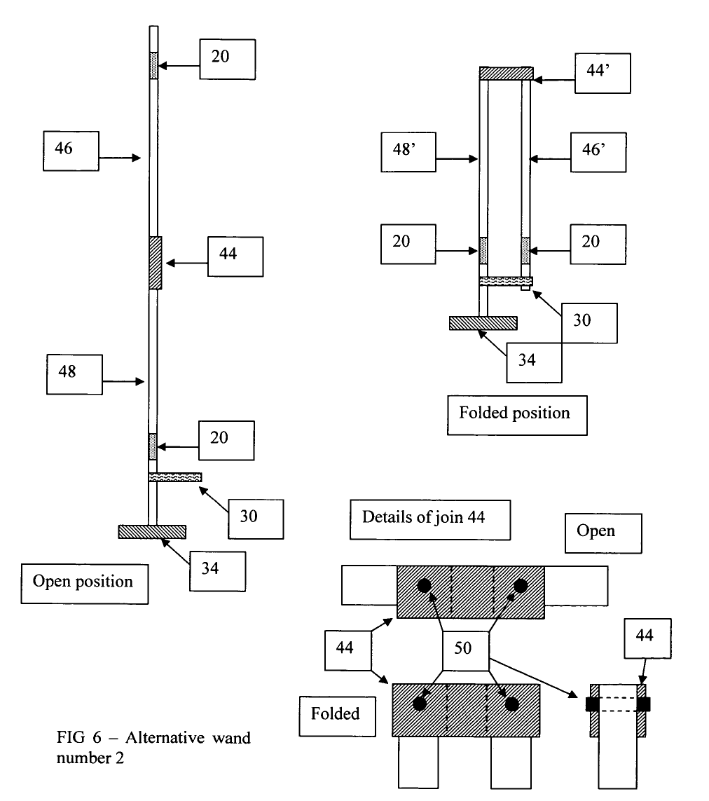

FIG. 5 is a view of an alternative design for the foldable deployment wand (“alternative wand number 1”) including a transverse handle 34. In this embodiment the lower piece 36 has a open yoke at the end away from the transverse handle into which the upper section 38 can fit with a flexible join 40. The joining pin 42 and the yoke are sized such that there is a reasonably tight friction fit between the pieces 36 and 38, so as to impart to the wand some mechanical rigidity when open but not so much friction as to prevent the two pieces to be folded into the closed position. The upper section 38 has an elongated L shape, such that there is room to accommodate the car cover when it is folded onto the deployment wand. This wand has the required Velcro® strips (or the like) 20 to allow it to be attached to the car cover itself.

FIG. 6 is a view of an alternative design for the foldable deployment wand (“alternative wand number 2”) including a transverse handle 34. In this embodiment the joining piece 44 is an open yoke that will accommodate both the upper 46 and lower section 48 of the foldable wand. The joining pin 50 and the yoke are sized such that there is a reasonably tight friction fit between the pieces 44 and the upper 46 and lower 48 section, so as to impart to the wand some mechanical rigidity when open but not so much friction as to prevent the two pieces to be folded into the closed position. This wand has the required Velcro® strips (or the like) 20 to allow it to be attached to the car cover itself. An elastic band (or the like) 30 is used to hold the wand in the folded position.

I claim:

1. A car cover comprising:
a. a sheet of flexible material capable of protecting a car or other vehicle surfaces against sun damage, natural elements such as birds, tree sap etc., sea spray, chemical sprays or pollutant runoff from elevated structures.
b. a series of small weights or magnets around the periphery of said cover to hold said cover in place during and after deployment.
c. several Velcro® strips or the like, to facilitate rolling said car cover onto a deployment device (“deployment wand”) to further facilitate deployment or removal of said car cover.

2. A car cover of claim 1, where two panels are fixed to the underside of the cover positioned such that they serve to hold said car cover firmly in place when the driver-side and passenger side doors are closed on them.

3. A car cover of claim 1, where two panels are fixed to the underside of the said car cover positioned such that they serve to hold said car cover firmly in place when the driver-side and passenger side doors are closed on them, with an additional rear panel at the rear of said car cover, of sufficient length that said rear panel can serve to hold said car cover firmly in place when the trunk lid of the vehicle is closed on it.

4. A car cover of claims 1, 2, and 3 in which the flexible material is composed to two sheets which may overlap or abut each other and are attached to each other at a small number of points in order to facilitate folding said car cover when rolled onto the deployment device (“deployment wand”).

5. A car cover of claims 1, 2, 3 and 4 in which provision is made for slits or other openings in the flexible material to allow antenna or other protrusions from the vehicle to pass through the car cover material.

6. A car cover of claims 1, 2, 3 and 4 in which provision is made for other modes of attaching said car cover, utilizing the side mirrors of the vehicle or adding a cord or cords to the front and/or back of the car cover which may be tied onto appropriate surfaces of the vehicle or attached with hooks

7. A deployment device (“deployment wand”) comprising:
a. two joined tubes of sufficient total length to accommodate the width of the car cover in claims 1-6 when said car cover is folded along its length on the left and right sides of said car cover and sufficient length that the user can manipulate the deployment wand conveniently while standing next to the vehicle or walking alongside said vehicle while deploying or removing said car cover.
b. Velcro® material or the like wound around portions of the deployment wand which can be attached to the car covers of claims 1-6 by means of the matching Velcro® material or the like that is part of said car covers.
c. a flexible material such as rubber or plastic tubing or a spring that joins the two halves of said deployment wand such that the deployment wand can be folded for compact storage when the interior support rod is the “withdrawn” position.
d. a support rod that can move freely within the deployment wand, such that in the “forward” position it stiffens the flexible deployment wand to facilitate deployment of the car covers in claims 1, 2 and 3 and in the “withdrawn” position it allows the deployment wand to be folded back on itself for compact storage.
e. a handle at one end of the deployment device, which may be removable, to facilitate the rotation action required of the deployment wand for deployment or removal of said car cover.
f. provision for a flexible band or laces to be fixed near the handle to allow the folded deployment wand to be held in the folded position securely.

8. A device of claim 7 (“deployment wand”) which may or may not be tubular comprising
a. two joined pieces, one of which has an L shape such that when the device is in the folded configuration that there is adequate clearance between the two pieces to accommodate the rolled-up car cover and of sufficient total length to accommodate the width of the car cover in claims 1-6 when said car cover is folded along its length on the left and right sides of said car cover and sufficient length that the user can manipulate the deployment wand conveniently while standing next to the vehicle or walking alongside said vehicle while deploying or removing said car cover.
b. Velcro® material or the like wound around portions of the deployment wand which can be attached to the car covers of claims 1-6 by means of the matching Velcro® material or the like that is part of said car covers.
c. a handle at one end of the deployment device, which may be removable, to facilitate the rotation action required of the deployment wand for deployment or removal of said car cover.
d. provision for a flexible band or laces to be fixed near the handle to allow the folded deployment wand to be held in the folded position securely.

9. A device of claim 7 (“deployment wand”) which may or may not be tubular comprising
a. two pieces joined by a common cross piece of sufficient length that there is adequate clearance between the two pieces to accommodate the rolled-up car cover and of sufficient total length to accommodate the width of the car cover in claims 1-6 when said car cover is folded along its length on the left and right sides of said car cover and sufficient length that the user can manipulate the deployment wand conveniently while standing next to the vehicle or walking alongside said vehicle while deploying or removing said car cover.
b. Velcro® material or the like wound around portions of the deployment wand which can be attached to the car covers of claims 1-6 by means of the matching Velcro® material or the like that is part of said car covers.
c. a handle at one end of the deployment device, which may be removable, to facilitate the rotation action required of the deployment wand for deployment or removal of said car cover.
d. provision for a flexible band or laces to be fixed near the handle to allow the folded deployment wand to be held in the folded position securely.
